(19) United States
(12) Patent Application Publication
(10) Pub. No.: US 2015/0230492 A1
(43) Pub. Date: Aug. 20, 2015

(54) METHOD AND APPARATUS FOR COFFEE PROCESSING

(71) Applicant: Neil M. Day, Jr., Portola Valley, CA (US)

(72) Inventor: Neil M. Day, Jr., Portola Valley, CA (US)

(21) Appl. No.: 14/624,377

(22) Filed: Feb. 17, 2015

Related U.S. Application Data
(60) Provisional application No. 61/941,315, filed on Feb. 18, 2014.

(51) Int. Cl. A23F 5/08; B65B 31/04; B65B 31/02

(52) U.S. Cl. CPC A23F 5/08; B65B 31/02; B65B 31/04

(57) ABSTRACT

A system and method for packaging coffee is presented. Coffee is packaged in an oxygen-free environment to eliminate or minimize the presence of oxygen in the package. Coffee that is packaged according to the system and method presented herein produces coffee drinks that are more flavorful than coffee that is vacuum-packed after already having been exposed to oxygen. The oxygen-free environment may be created by an atmospheric isolation chamber having an inlet and an outlet, a mechanism configured to maintain oxygen level in the chamber at below a predefined level, and a coffee packaging tool inside the isolation chamber.

### RELATED APPLICATION(S)

This application claims the benefit of U.S. Provisional Application No. 61/941,315 filed on Feb. 18, 2014, the content of which is incorporated by reference herein.

### BACKGROUND

The inventive concept disclosed herein relates to a method and apparatus for processing coffee to preserve freshness.

Coffee today is largely available in stores as roasted whole beans and grounds. As coffee is usually ground before being brewed, purchasing coffee grounds is the more convenient choice between the two for an average consumer. By purchasing the grounds, one can save time and effort involved in grinding the beans. However, in spite of this obvious convenience, whole beans remain a popular choice among coffee drinkers. The reason is that if a relatively long time elapses between the grinding of the roasted coffee beans and the preparation of the coffee beverage, a noticeable amount of the coffee flavor and aroma may get lost. One of the culprits of the flavor deterioration is the coffee's reaction with oxygen in the atmosphere. Oxidation changes the chemical makeup of coffee, making it taste “stale.”

When coffee beans are ground, the surface area of the coffee is increased by several orders of magnitude. A result of the larger surface area is that there are more places where the oxygen in the atmosphere can “stick” to and oxidize the coffee. Whereas whole bean coffee will remain relatively fresh for several weeks, ground coffee could start to lose freshness in a matter of minutes.

Another factor that negatively impacts coffee flavor is the evaporation and sublimation of volatile compounds that contribute to the richness of the resulting beverage. There are hundreds of compounds in roasted coffee that enriches and deepens the flavor of the coffee drink but a lot of these compounds get lost during exposure to the atmosphere, rendering the coffee “flat.”

Being aware of the negative impact atmospheric exposure has on coffee flavor, the coffee industry has made much effort to preserve the freshness and flavor of coffee. For example, coffee is often vacuum-packed to minimize the chances of oxidation while the product is sitting on a shelf or being transported. In fact, much effort is dedicated to removing the oxygen from the package after the beans are packed, or to making sure oxygen does not creep into the package. However, by the time the vacuum packing is done, the ground coffee has already been “damaged” by oxidation. Furthermore, as oxygen that is already on the coffee surface often cannot be unbound or “cleaned off” by vacuum or flushing, degradation continues even after vacuum packing is completed. Hence, while purchasing pre-ground coffee would be convenient, many consumers are forced to purchase whole beans to make flavorful coffee drinks.

Different coffee makers and coffee storage containers are available today to keep the coffee beans/grounds separated from oxygen as much as possible for as long as possible. However, oxygen making up about 20% of atmospheric air, roasted coffee beans still experience significant flavor degradation even with the above precautions. A method and apparatus for further reducing oxidation of coffee beans and loss of flavor-enriching compounds is desired.

### SUMMARY

In one aspect, the inventive concept includes a method of packaging coffee by packaging coffee in an oxygen-free environment.

In another aspect, the inventive concept pertains to a method of packaging coffee by receiving coffee into an atmospheric isolation chamber that is controlled to maintain oxygen level below a predefined maximum level, placing the predefined amount of coffee in a package inside the atmospheric isolation chamber, and sealing the package in the atmospheric isolation chamber.

In yet another aspect, the inventive concept pertains to a system for packaging coffee beans. The system includes an atmospheric isolation chamber having an inlet and an outlet, a mechanism configured to maintain oxygen level in the atmospheric isolation chamber at below a predefined level, and a coffee packaging tool inside the isolation chamber.

In yet another aspect, the inventive concept pertains to a system for controlling coffee processing and packaging that includes an oxygen-free chamber holding equipment for packaging coffee, a user interface including an area that displays oxygen level in the chamber, and an oxygen level adjustment mechanism connected to the chamber. The oxygen level adjustment mechanism is triggered to reduce oxygen level in the chamber in response to the oxygen level in the chamber rising above a predetermined level.

### BRIEF DESCRIPTION OF THE DRAWINGS

FIG. 1 is a flowchart illustrating an oxygen-free coffee processing method.

FIG. 2 is a schematic illustration of the oxygen-free processing method.

FIG. 3 is a schematic illustration of the isolation chamber where oxygen-free processing method is executed.

FIG. 4 is an example of a screen displayed by the computer that is connected to the isolation chamber of FIG. 3.

### DETAILED DESCRIPTION

The inventive concept pertains to eliminating or minimizing the presence of oxygen in packaged coffee by carrying out the packaging process in an oxygen-free environment. An “oxygen-free” environment, as used herein, is an environment where oxygen level is no higher than 500 ppm. “Coffee,” as used herein, is intended to include both whole beans and ground. “Inert gas,” as used herein, refers to gas that does not chemically react with coffee, including but not limited to nitrogen and argon.

The inventive concept pertains to providing a sealed container holding coffee beans, wherein the sealed container is free of oxygen, placing the sealed container in an atmospheric isolation chamber, removing oxygen from the atmospheric isolation chamber, and processing the coffee beans in the atmospheric isolation chamber. Parts of the process may be automated.

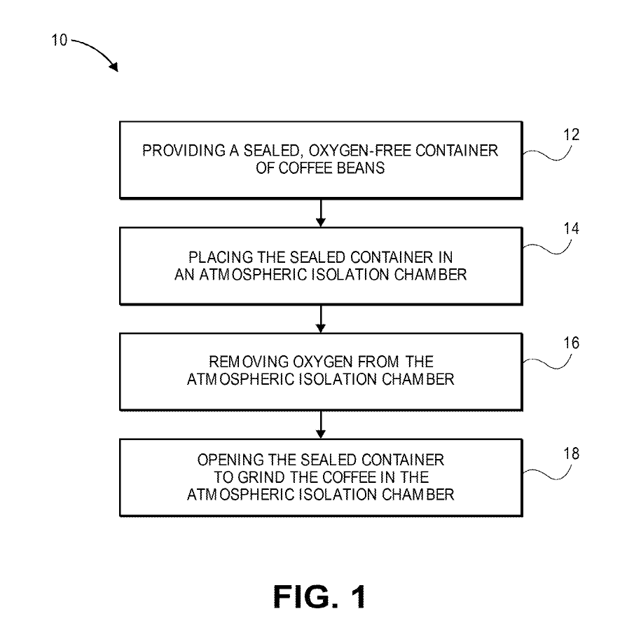

FIG. 1 is a flowchart illustrating an oxygen-free coffee processing method 10 in accordance with an aspect of the inventive concept. As shown, the oxygen-free processing method 10 begins with obtaining a sealed, oxygen-free container of coffee beans (step 12). The coffee beans may be already roasted. The sealed container of coffee beans may be obtained in a state that is ready for use, for example if the coffee beans were stored in the sealed container shortly after being harvested and roasted to minimize exposure to oxygen. Alternatively, the sealed containers may be prepared by obtaining the containers, placing the coffee beans inside, sealing the container, pumping the air out of the container and/or flushing the inside of the container with an inert gas (e.g., nitrogen, argon). In some embodiments, the coffee beans may be weighed or otherwise measured before being placed in the sealed containers. In some embodiments, some processing equipment may also be placed in the oxygen-free sealed container with the coffee beans.

The oxygen-free sealed container is placed in an atmospheric isolation chamber (step 14). The sealed container, as well as other equipment, etc., may be placed in the isolation chamber using an airlock. The isolation chamber is then purged such that almost all the oxygen is removed (step 16). A vacuum pump may be used for the removal of air inside the chamber, and/or the chamber may be flushed with an inert gas such as nitrogen or argon. In one embodiment, the oxygen content in the chamber is brought to less than 100 ppm before coffee processing begins.

In an oxygen-free isolation chamber, the coffee beans are taken out of the sealed container and processed (step 18). If desired, the beans may be weighed to measure out a desired amount for a package at this stage. The beans are then put in a grinder to be ground to a desired particle size, and sealed in a package. The beans may be weighed before or after the grinding, if the weighing has not been done before the coffee was stored in the sealed container. Different grind sizes may be blended to put together a package that would produce an appealing coffee flavor. The package is then sealed. Conventional coffee packaging equipment and techniques that are available in the market may be used in the isolation chamber, as long as the packaging system maintains a high oxygen barrier to prevent the coffee from coming into contact with oxygen. The sealed package is then brought out of the isolation chamber.

In some embodiments, the oxygen level in the isolation chamber is monitored in real-time, continuously or periodically. The vacuum pump system and/or the inert gas flushing system may be programmed to automatically activate when the oxygen level reading rises above a threshold level. In some embodiments, the isolation chamber may be a “glove box”-type chamber that allows human intervention when desired. In other embodiments, at least parts of the process in the isolation chamber is automated. Automation may include some type of mechanism (e.g., a conveyor belt, robotic arm) that moves the coffee from one station to the next inside the atmospheric isolation chamber 30.

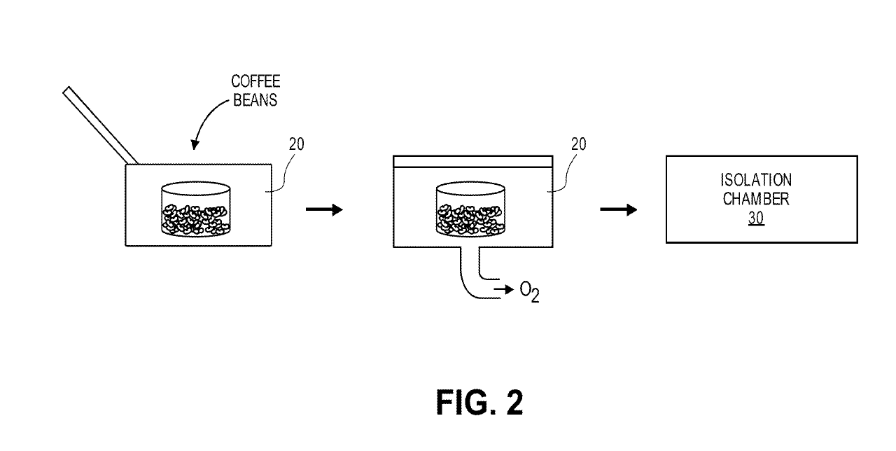

FIG. 2 is a schematic illustration of the oxygen-free processing method 10. The embodiment shown includes preparation of the oxygen-free sealed container 20 but as mentioned above, a pre-packaged sealed container containing coffee beans may be obtained. Whole roasted coffee beans are poured into an open container 20 (step 22). The container is then sealed and oxygen is removed to prepare the oxygen-free sealed container 20 (step 24). The container 20 is then placed in the isolation chamber 30 through an airlock 40a, which may be a small chamber with two airtight doors. A conveyor belt mechanism, a robotic arm, or a human operator may move the container 20 into the airlock 40a and then into the isolation chamber 30.

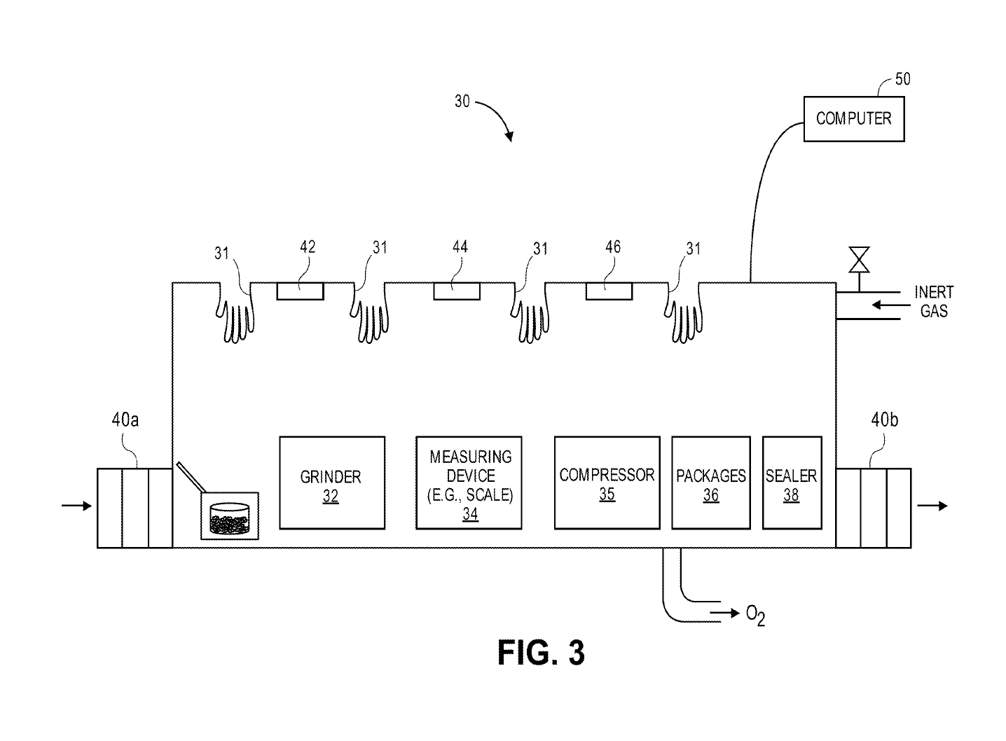

FIG. 3 schematically illustrates the isolation chamber 30. Once the sealed container 20 is in the isolation chamber 30, the isolation chamber is purged by a vacuum pump and/or inert gas flush. The container 20 is then opened, the coffee beans are taken out, and moved through various stages of the process 10. The coffee beans are placed in the grinder 32. The settings for the grinder (e.g., blade size and type, grind time) are provided in a specification that is received through the user interface of a computer 50 that controls the isolation chamber 30. The grinder 32 is then automatically turned on according to specification for the preset amount of time, and the desired amount of grounds is measured (e.g., by a measuring device 34, such as a scale). The measured grounds may then be compressed into a slug to limit evaporation of volatile compounds (e.g., by a compressor 35), placed in a package/bag 36 and sealed by a package sealer 38.

The isolation chamber 30 may be automated, equipped with mechanisms for moving the coffee from one stage to the next accurately. The physical components for carrying out each automated stage of the process 10 may be herein referred to as a “station.” The isolation chamber 30 may have a “glove box”-type airtight gloves 31 positioned on its walls and/or roof in case human intervention is desired. A human operator may insert his hands into the gloves 31 and move, fix, refill packages, or perform some other type of task while the isolation chamber 30 is in oxygen-free state, without affecting the oxygen level inside the chamber 30. If desired or needed, the entire process 30 may be carried out manually using the gloves 31.

The package/bag 36 is any type of container capable of holding the coffee while keeping its content separated from oxygen. In one embodiment, the package/bag 36 may be airtight. The package/bag 36 may be designed to keep oxygen level inside at a minimum level, or incorporate some type of mechanism or chemistry to prevent oxygen from contacting the coffee. The package/bag 36 may be a tin, a bag, a box, or any other means of holding the coffee and is not limited to a specific shape, design, or material. Depending on the exact type of package/bag 36 that is used, the package sealer 38 may not be necessary.

The coffee grounds in the sealed package are then automatically moved out of the isolation chamber 30. In some embodiments, there may be an airlock 40b along the exit end of the chamber 30.

A plurality of containers 20 may serially enter the isolation chamber 30. In some cases, different containers 20 will be going through different stages of the process inside the isolation chamber 30, for high throughput and efficient production. The amount of time the coffee spends at each station will be precisely controlled to optimize the production. An oxygen level sensor 42 placed inside the isolation chamber 30 constantly monitors the oxygen level inside the chamber 30 and selectively and automatically activates the vacuum pump mechanism and the inert gas flush mechanism to keep the conditions inside the chamber 30 optimal. Various other sensors, such as a thermometer 44 or a moisture level sensor 46 may be positioned in the isolation chamber 30.

It should be understood that by skipping the grinder station, the process and apparatus described above can be used to package whole beans.

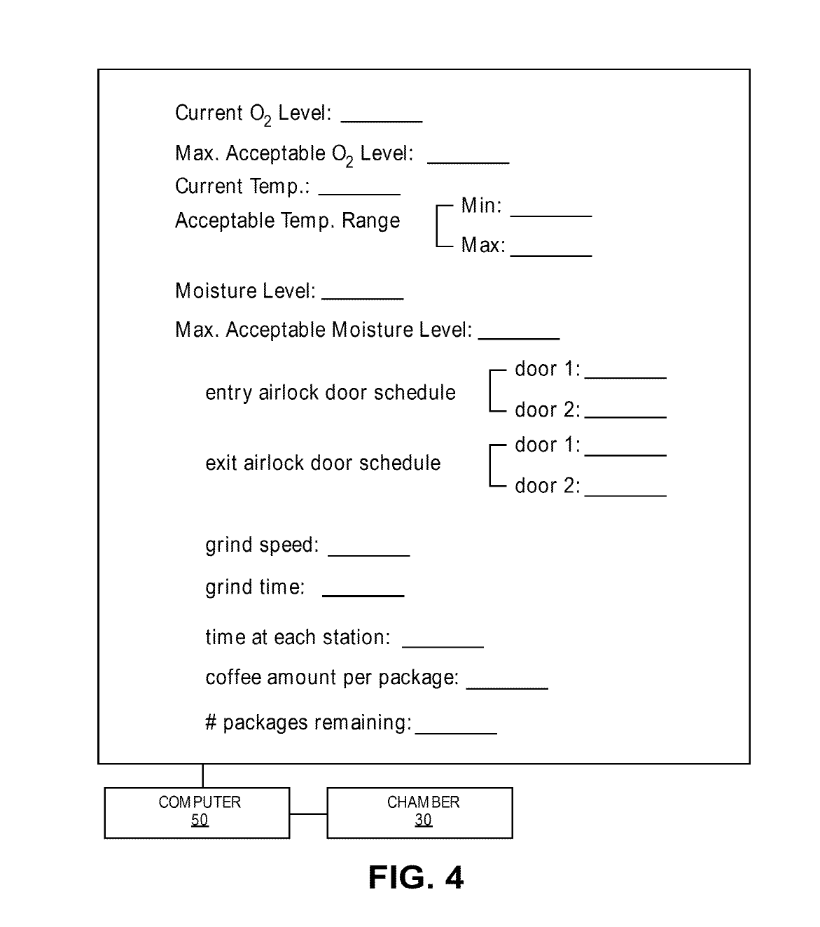

FIG. 4 is an example of a visual user interface connected to the computer 50 that may be used by an operator to control the operations inside the isolation chamber 30. As shown, the computer 50 receives data from the oxygen sensor 42, the thermometer 35, and the moisture level sensor 37 and displays them on a user interface component (e.g., a monitor). In addition, threshold levels for these sensor readings may be set so that if the conditions inside the chamber 30 become less than optimal, appropriate action is automatically taken to adjust the conditions back to the desired state. Although not explicitly shown in FIG. 3, there are mechanisms for changing the temperature and moisture level in the chamber 30.

As shown in FIG. 4, one of the parameters in the specification that can be set is the amount of time a batch of coffee spends at each station in the chamber 30. The desired grind time for coffee beans will vary according to various parameters including but not limited to moisture content, brittleness, type of bean, and degree of roasting experienced by the beans.

Embodiments of the disclosure and the functional control operations described in this specification can be implemented in digital electronic circuitry, or in computer software, firmware, or hardware, including the structures disclosed in this specification and their structural equivalents, or in combinations of one or more of them. The computer 50 can be implemented as a combination of computer hardware including a processor and a memory with one or more computer program products, i.e., one or more modules of computer program instructions encoded on a computer-readable medium for execution by, or to control the operation of, data processing apparatus. The method of the disclosure may be executed in small scale cost-effectively. However, it is also scalable such that the process 10 to be carried out in different locations (e.g., near where the beans are harvested), with a central server that controls the different isolation chambers 30 located in different cities that are interconnected via one or more communication networks.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Embodiments can be implemented using a computer (e.g., computer 50) having a display device, e.g., a CRT (cathode ray tube), LCD (liquid crystal display), projection screen, OLED display, 3D display, etc. for displaying information to the participants. A keyboard and a pointing device, e.g., a mouse or a trackball, by which a conference participant can provide input to the computer are also provided. Other kinds of devices can be used to provide for interaction with participants as well; for example, feedback provided to the player can be any form of sensory feedback, e.g visual feedback, auditory feedback, or tactile feedback; and input from the player can be received in any form, including acoustic, speech, brain waves, other physiological input, eye movements, gestures, body movements, or tactile input.

Embodiments can be implemented in a computing system that includes a back-end component (e.g., a central server), a middleware component (e.g., an application server), or a front-end component (e.g., a computer at a terminal having a graphical player interface or a Web browser) through which a player can interact with an implementation of the inventive concept, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

While this disclosure contains many specifics, these should not be construed as limitations on the scope of the disclosure or of what can be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. For example, it is possible for a large amount of coffee beans to be ground, and then measured out into multiple packages instead of beans for one package being ground at a time. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

It should be understood that the inventive concept can be practiced with modification and alteration within the spirit and scope of the disclosure. The description is not intended to be exhaustive or to limit the inventive concept to the precise form disclosed.

What is claimed is:

1. A method of packaging coffee, comprising grinding and packaging coffee in an oxygen-free environment.

2. A method of packaging coffee, comprising:
receiving coffee into an atmospheric isolation chamber that is controlled to maintain oxygen level below a predefined maximum oxygen level;
placing the coffee in a package inside the atmospheric isolation chamber; and
sealing the package in the atmospheric isolation chamber.

3. The method of claim 2, wherein the coffee is in the form of coffee beans, further comprising grinding the coffee beans inside the atmospheric isolation chamber.

4. The method of claim 2, wherein the coffee that is received is in an oxygen-free sealed container.

5. The method of claim 2 further comprising:
monitoring oxygen level inside the atmospheric isolation chamber; and
removing oxygen from the atmospheric isolation chamber periodically, in response to a rise in oxygen level.

6. The method of claim 2 further comprising:
monitoring oxygen level inside the atmospheric isolation chamber; and
supplying inert gas into the atmospheric isolation chamber.

7. The method of claim 2, wherein the predefined maximum oxygen level is 100 ppm.

8. The method of claim 2, further comprising preparing the coffee for receiving into the atmospheric isolation chamber, wherein the preparing comprises:
placing coffee in a container; and
sealing the container and removing oxygen from inside the container such that the container is received into the atmospheric isolation chamber.

9. The method of claim 2, further comprising measuring the coffee inside the atmospheric isolation chamber.

10. A system for packaging coffee beans, comprising:
an atmospheric isolation chamber having an inlet and an outlet;
a mechanism configured to maintain oxygen level in the atmospheric isolation chamber at below a predefined level; and
a coffee packaging tool inside the isolation chamber.

11. The system of claim 10, further comprising airtight gloves on a surface of the atmospheric isolation chamber.

12. The system of claim 10, wherein the mechanism comprises at least one of a vacuum pump and an inert gas supply.

13. The system of claim 10 further comprising an oxygen level sensor placed inside the isolation chamber.

14. The system of claim 13, wherein the mechanism is triggered to remove oxygen from the atmospheric isolation chamber in response to the oxygen level sensor sensing an oxygen level above the predefined level.

15. The system of claim 10 further comprising a moisture level sensor in the atmospheric isolation chamber.

16. The system of claim 10 further comprising a grinder inside the atmospheric isolation chamber, the grinder being configured to grind coffee beans according to specification.

17. The system of claim 10, wherein the inlet comprises an airtight chamber having an oxygen removal mechanism.

18. A system for controlling coffee processing and packaging, comprising:
an oxygen-free chamber holding equipment for packaging coffee;
a user interface including an area that displays oxygen level in the chamber; and
an oxygen level adjustment mechanism connected to the chamber, wherein the mechanism is triggered to reduce oxygen level in the chamber in response to the oxygen level in the chamber rising above a predetermined level.

19. The system of claim 18, further comprising a computer configured to receive processing specification including at least one of grind speed, grind time, temperature, and moisture level inside the chamber and selectively activate components to turn on and off a grinder inside the oxygen-free chamber or adjust temperature and moisture level inside the chamber.
